(19) United States
(12) Patent Application Publication
(10) Pub. No.: US 2009/0299769 A1
(43) Pub. Date: Dec. 3, 2009

(54) Prognostic osteoarthritis biomarkers

(75) Inventors: Erik B. Dam, Copenhagen (DK); Marco Loog, Rotterdam (NL); Morten Karsdal, Copenhagen (DK); Mads Nielsen, Dragor (DK); Claus Christiansen, Morcote (CH)

Correspondence Address: EDWARDS ANGELL PALMER & DODGE LLP, P.O. BOX 55874, BOSTON, MA, 02205, US

(73) Assignee: Nordic Bioscience Imaging A/S, Herlev (DK)

(21) Appl. No.: 12/455,171

(22) Filed: May 29, 2009

Related U.S. Application Data
(60) Provisional application No. 61/130,417, filed on May 29, 2008.

(51) Int. Cl. G06Q 50/00; G06N 5/02; G06K 9/00

(52) U.S. Cl. 705/3; 706/52; 382/128

(57) ABSTRACT

A computer based calculation of a prognostic index I of osteoarthritis based on biochemical and imaging based biomarkers a mathematical combination of said values, wherein a first imaging based biomarker is a measure of the quantity of a cartilage in a joint compartment, a second imaging based biomarker relating to the quality of said cartilage in said joint compartment, and wherein a value of said first biomarker indicative of a larger quantity of cartilage affects the index to make it predictive of more disease progression, and a value of said second biochemical marker indicative of a greater departure from the quality of disease free cartilage affects the index to make it predictive of more risk of disease progression, exemplified by

$$I = yHom + zVol + {\sum }_{n = 1}^{N} {a}_{n} {Other}_{n}$$

where y and z are numerical coefficients, Hom is the measured homogeneity, Vol is the measured cartilage volume, and where Otherₙ represents N further biomarkers each having a respective numerical coefficient aₙ, N being zero or an integer.

### BACKGROUND OF THE INVENTION

The present invention relates to the provision of a computer based method for the calculation of a prognostic index in respect of osteoarthritis based on biochemical and imaging based biomarkers.

Osteoarthritis (OA) has a large impact on the daily lives of the individuals suffering from the disease in terms of reduced work-ability and limitations on physical activity in general due to pain and limited mobility. The prevalence of the disease also implies a large socio-economic impact—the economic burden of arthritis may be up to 2.5% of the gross national product in western countries. Furthermore, the lack of effective treatment beyond symptom control (i.e. pain relief) aggravates these implications. For the individual it adds a state of pessimism, and for society the gradual ageing of the population will be likely to increase the economic burden.

There are many factors in the onset of OA including genetics, trauma, biomechanics, weight and exercise. Furthermore, after the onset there are several phases with very different characteristics. During early OA, structural changes are observed that cause increased turnover of cartilage and bone. This phase is followed by cartilage fibrillation, thickening of the subchondral bone, bone lesion oedema, osteophytes, focal cartilage lesions, and finally during the later stages of OA cartilage loss leading to denudation is observed. During these stages, related effects such as meniscal subluxation and attrition are also often observed. The exact disease progression is individual but formation of osteophytes, subchondral bone thickening, and cartilage loss seems to be common. However, still there are differences in the most prominent compartments for the individual and in the progression rate.

There is therefore a need to be able to identify patients for a treatment group and for a control group for clinical trials who have e.g. early stage osteoarthritis and to be able to identify amongst those candidates patients who have a relatively high probability that their disease will progress noticeably within the time period of the trial if left untreated.

Much research has been devoted to development of a disease modifying OA drug (DMOAD). A complicating factor is the slow, complex progression of the disease. The complexity may cause the need for joint replacement surgery (JRS) to be the most reliable clinical endpoint—and the slow progression until JRS makes evaluation of the treatment efficacy of potential DMOADs very lengthy. This hinders experiments and also implies a huge development cost. While the final acceptance of a DMOAD must be based on evaluation against an established clinical endpoint, the problems caused by the slow, complex progression of OA can to some degree be alleviated by the use of surrogate biomarkers. Initially, such markers can allow early experiments with relatively short durations looking into the effects and appropriate dosages of potential DMOADs. Also, several types of biomarkers are needed for clinical studies. Following the BIPED classification (1, 2), a diagnostic marker is needed to ensure that the study population is at the OA stage that the potential DMOAD targets, a prognostic marker is also needed in the study selection criteria to ensure that the study population has a high risk of disease progression if left untreated, and finally an efficacy of intervention (or efficacy) marker is needed to quantify the treatment effect.

It is important to select—for a clinical investigation or trial—patients who left untreated will have a high likelihood of disease progression as the inclusion in either a treatment group or a control group of patients who would not have had disease progression when left untreated will just serve to mask any effect that the treatment may have.

Therefore, surrogate markers can be used as diagnostic and prognostic markers even if no direct relationship with the clinical endpoints has been demonstrated. Eventually, once a first clinical study has established a clear connection between a surrogate marker and clinical endpoints, that marker can be used as efficacy marker in clinical trials and thereby make treatment development much quicker and more cost-effective.

This need for biomarkers for clinical studies has led to research focusing on markers that appear promising as surrogate biomarkers for OA. Most prominently, the bone and cartilage related effects during OA have inspired development of markers that quantify bone/cartilage turnover as well as aspects of structural integrity. Among these are the biochemical markers from systemic fluids for bone turnover such as of collagen type I markers (e.g. CTX-I and NTX) and cartilage turnover markers such as collagen type II (e.g. CTX-II (3)) and aggrecan markers (e.g. G1-G2 (4)) (for a review on biochemical markers, see (5)).

Whilst the markers based on systemic fluids are suitable for offering a measure of the overall burden of the disease (a combination of the number of joints affected and the severity in each joint), they offer very little information on the individual joint or compartment.

For focal quantification, imaging-based markers are more applicable. Traditionally, osteophytes and joint space width (JSW) have been quantified from radiographs, and currently the Kellgren & Lawrence index (KLi) is an accepted standard for the degree of OA. JSW has also traditionally been used as outcome measure in clinical studies. In recent years, magnetic resonance imaging (MRI) is emerging as a promising modality for OA quantification since MRI offers non-invasive 3D visualization of the soft tissue as well as the bone. Most documented MRI-based diagnostic markers have focused on cartilage and have been related to the quantity of cartilage present, i.e. volumetric (volume (6), thickness (7)) but also markers targeting the ‘quality’ of the cartilage such as cartilage shape (surface curvature and smoothness (8)) and cartilage structure (dGEMRIC (9), T2 & T1rho (10), and homogeneity (11)) have been proposed (for a review, see (12)).

Apart from the difference in global/compartmental view, there are also other major differences between biochemical and imaging-based markers. The biochemical markers offer dynamic quantification of the current turnover/formation/degradation. In contrast, most imaging-based markers provide measurements of the current static status.

However, the complexity of OA makes progression biomarker development challenging. Qi et al (13) reported an association between elevation of each of the biochemical biomarkers cartilage oligomeric protein (COMP), matrix metalloproteinase-1 (MMP-1), and tissue inhibitor of matrix metalloproteinases-1 (TIMP-1) and exercise induced MRI changes.

Cartilage homogeneity has been proposed as a diagnostic OA marker, but has no established role as a progression marker (14).

Bruyere et al (15) reported that whilst a single measurement of serum hyaluronic acid could identify patients at greatest risk of progression of osteoarthritis, a single measurement of urine CTX-II (type II collagen telopeptide fragments) could not, although short term changes in CTX-II were possibly predictive.

Mazieres et al (16) reported that urinary CTX-II and serum hyaluronan, but not COMP, were each predictive of disease progression, alone or in combination, but the association between baseline levels of the markers and radiological progression was only modest and that molecular markers cannot accurately predict the absolute rate of progression in a given patient.

Garnero et al (17) reported that a combination of the cartilage formation marker PIIANP and urinary CTX-II showing an uncoupling of formation and resorption could be useful in identifying patients at high risk of rapid progression in knee OA.

Hunter et al (18) however reported that only COMP and not assays for type I or type II collagen cleavage products (including Col2Ctx), type II synthesis (C-propeptide), or aggrecan showed statistical significance as predictors for MRI determined cartilage loss in a longitudinal study.

Roux-Lombard et al (19) on the other hand reported that only proMMP-3 and not COMP out of several biochemical markers studied was predictive and that only to a low extent in respect of progression of rheumatoid arthritis.

### BRIEF SUMMARY OF THE INVENTION

We have now found that a combination of at least two and preferably at least three biomarkers including one relating to the quantity of the cartilage in an affected joint, one relating to the quality of said cartilage, and preferably one relating to the rate of breakdown of a cartilage component can provide a tool for improved discrimination between patients in which osteoarthritis is likely to progress and those in which it is less likely to progress and that surprisingly, in such a combination a relatively high value for a biomarker related to cartilage quantity is a sign of a likelihood of disease progression.

Accordingly, the invention provides a computer based method for the calculation of a prognostic index in respect of, e.g. early stage, osteoarthritis based on biochemical and imaging based biomarkers comprising inputting to or computing in a computational apparatus values of at least two biomarkers and calculating a said index by a mathematical combination of said values, wherein at least one said biomarker is a first imaging based biomarker which is a measure of the quantity of a cartilage in a joint compartment, and at least one said biomarker is a second imaging based biomarker relating to the quality of said cartilage in said joint compartment, and wherein a value of said first biomarker indicative of a larger quantity of cartilage affects the index to make it predictive of more disease progression, and a value of said second biochemical marker indicative of a greater departure from the quality of disease free cartilage affects the index to make it predictive of more risk of disease progression.

Whilst the number of biomarkers that are combined to form the index is not limited, it is preferred that the number is not excessive. Preferably, up to 5 or 6 biomarkers may be used. Where more than 5 or 6 biomarkers are combined it is preferred that the selection of biomarkers is such that no more than 5 or 6 of the combined biomarkers provide at least 70% of the information content of said index. Alternatively expressed, the method may be such that more than 5 biomarkers are combined but such that no more than 5 of the combined biomarkers would provide an aggregate marker with a performance that is not significantly below (statistically) the performance of the full marker.

Thus, the invention does not exclude methods in which further biomarkers are used but do not materially affect the value of the index. The value of the invention can however be obtained without the use of such an excessive number of biomarkers. Preferably, therefore no more than 6 biomarkers are combined to form said index. However, to obtain a preferred level of predictive ability preferably at least 3 biomarkers are combined to form said index.

Preferably, said first imaging based biomarker relating to the quantity of cartilage is selected from the group consisting of cartilage thickness at a location, cartilage mean thickness, cartilage volume, or thickness/volume measured in a anatomical compartment, compartment sub-region, or in a region-of-interest in general, as measured from a digital image of the cartilage. Volume is the preferred quantity biomarker.

Preferably, said second imaging based biomarker relating to the quality of said cartilage is selected from the group consisting of congruity, surface curvature, surface smoothness, cartilage composition, cartilage fibre alignment and homogeneity, each as measured from a digital image of the cartilage. Homogeneity is the preferred quality biomarker. Homogeneity may be measured from a digital image of a joint cartilage as described in PCT/EP2007/059899 and in Reference 14.

Congruity, surface curvature, and surface smoothness/roughness, can be measured as described in: Reference 7. Fibre Alignment can be measured as described in Reference 31. Composition may be measured as described in Reference 32. Area may be measured as described in Reference 27.

The cartilage composition may in particular relate to the content of glycosaminoglycan or water (hydration) of the cartilage.

Cartilage smoothness and cartilage roughness are essentially the inverse of one another. Either may be used, the numerical weighting of this biomarker in the index being adjusted accordingly.

Area as measured from a digital image of cartilage is dependent on the smoothness/roughness of the cartilage surface, such that more roughness produces a higher surface area.

The image is preferably an MRI image. Optionally, it may be an MRI with a contrast agent (as in dGEMRIC) or diffusion tensor MRI. Alternatively, Computed Tomography (CT) or contrast-enhanced CT may be used. For inspection of in-vitro data, histology is an alternative.

Said first and second imaging based biomarkers are preferably (1) cartilage volume and (2) cartilage homogeneity, and greater homogeneity affects the index to make it predictive of more disease progression.

Preferably, said first imaging based biomarker relates to the joint compartment of a knee and more preferably, said first imaging based biomarker is indicative of volume of at least one articular cartilage of a compartment/region in said knee.

Optionally, at least three biomarkers are combined to form said index, and at least one said biomarker is a biochemical biomarker which is a measure of a rate of breakdown of a component of said joint, and a value of the biochemical marker indicative of a higher rate of breakdown of said joint component affects the index to make it predictive of more risk of disease progression.

Said biochemical marker may be a concentration measured in a body fluid sample of a cartilage degradation product. Said cartilage degradation product may be a peptide or group of related peptides produced by breakdown of a cartilage protein. Suitably, the cartilage protein is collagen type II, aggrecan, or COMP.

Optionally, at least 3 biomarkers are combined to form said index which are (1) cartilage volume, (2) cartilage homogeneity, and (3) a biochemical marker of cartilage type II degradation.

Optionally, at least 5 biomarkers are combined to form said index which are (1) cartilage volume, (2) cartilage homogeneity, (3) a biochemical marker of collagen type II degradation, (4) cartilage roughness, and (5) cartilage area.

Optionally, at least one additional biomarker is included in any said index described previously which is indicative of the state of a structural component of the joint other than articular cartilage. For example, such an additional biomarker may relate to bone formation or resorption, or changes in bone shape, or changes in meniscal cartilage.

Although as described below, various ways of combining the biomarker values to form such an index are possible, we prefer that the index is calculated according to a linear weighted sum of the measured biomarkers. Thus, said index may be calculated to provide the information content of I such that:

$$I = yHom + zVol + {\sum }_{n = 1}^{N} {a}_{n} {Other}_{n}$$

where y and z are numerical coefficients, Hom is the measured homogeneity, Vol is the measured cartilage volume, and where Otherₙ represents N further biomarkers each having a respective numerical coefficient aₙ, N being zero or an integer.

A more predictive index can be obtained if said index is calculated to provide the information content of I such that:

$$I = xDeg + yHom + zVol + {\sum }_{n = 1}^{N} {a}_{n} {Other}_{n}$$

where x, y, and z are numerical coefficients and Deg is the measured value of the biochemical marker of collagen type II degradation, Hom is the measured homogeneity, and Vol is the measured cartilage volume, and where Otherₙ represents N further biomarkers each having a respective numerical coefficient aₙ, N being zero or an integer.

A still more predictive index can be obtained if said index is calculated to provide the information content of I such that:

$$I = xDeg + yHom + zVol + wRough + vArea + {\sum }_{n = 1}^{N} {a}_{n} {Other}_{n}$$

where v, w, x, y, and z are numerical coefficients and Deg is the measured value of the biochemical marker of collagen type II resorption, Hom is the measured homogeneity, Vol is the measured cartilage volume, Rough is the measured cartilage roughness and Area is a measured cartilage area, and where Otherₙ represents N further biomarkers each having a respective numerical coefficient aₙ, N being zero or an integer.

A simple index I according to the invention can be calculated to provide the information content of:

I=yHom+zVol

where y and z are numerical coefficients (weights), Hom is the measured homogeneity, Vol is the measured cartilage volume, and wherein y=from 0.4 to 4.3, and z=from 0.1 to 1.2, when the units of Hom and Vol are scaled so that each has a standard deviation of 1 (where the standard deviation is calculated over measurements of the marker performed over a population composed of both healthy and diseased subjects).

The measured values of the biomarkers will in the first instance be in some particular units and the absolute value obtained will be different if different units are adopted. This will reflect directly in the numerical coefficients when the biomarkers are combined. To obtain coefficients for use in the formulae herein which are independent of the units of measurement, the measured values for each biomarker have been rescaled such that they have a standard deviation of 1. Of course, it is computationally equivalent to use biomarker measurements that have not been rescaled and to adjust the values of the coefficients accordingly. Any such equivalent method of calculation is in accordance with this preferred aspect of the invention. Equally, the index I may be more generally expressed as any function of I, for instance I raised to any power, or subtracted from an arbitrary number or the like. All that is of significance is that the information content of the index is preserved.

For best prognostic performance, y=0.72 and z=0.69, each ±20%, more preferably ±10%, still more preferably ±5%.

A somewhat more sophisticated index according to the invention capable of providing improved prognostic performance can be calculated to provide the information content of:

I=xDeg+yHom+zVol

where x, y, and z are numerical coefficients and Deg is the measured value of the biochemical marker of collagen type II degradation, Hom is the measured homogeneity, and Vol is the measured cartilage volume.

Preferably, x=from −0.1 to +1.7, y=from 0.1 to 3.2, and z=from 0.1 to 2.5, the units of Deg, Hom and Vol being scaled so that each has a standard deviation of 1. More preferably, x=from 0.01 to 1.3, y=from 0.3 to 1.9, and z=from 0.3 to 1.2. Optimally, x=0.44, y=0.65 and z=0.63, each ±20%, more preferably ±10%, still more preferably ±5%.

Still better prognostic performance can be obtained if the index is calculated to reflect the information content of:

I=xDeg+yHom+zVol+uRgh+vAr

where u, v, x, y, and z are numerical coefficients and Deg is the measured value of the biochemical marker of collagen type II resorption, Hom is the measured homogeneity, Vol is the measured cartilage volume, Rgh is the measured cartilage roughness and Ar is the measured cartilage area.

Preferably, u=from −0.15 to +0.7, v=from −0.7 to +0.2, x=from −0.05 to +1.3, y=0 to 2.5, and z=from 0.4 to 1.5, the units of Vol, Rhg, Deg, Hom and Vol being scaled so that each has a standard deviation of 1. More preferably, u=from −0.05 to +0.6, v=from −0.6 to −0.1, x=from 0.05 to 0.8, y=0.05 to 1.2, and z=from 0.5 to 1.2. Optimally, u=0.17, v=−0.48, x=0.2, y=0.3 and z=0.78, each ±20%, more preferably ±10%, still more preferably ±5%.

If one chooses to include in addition a biomarker which relates to something other than the condition of the articular cartilage in a joint, a suitable index contains the information content of:

I=xDeg+yHom+zVol+uRgh+vAr+tBone

where t, u, v, x, y, and z are numerical coefficients and Deg is the measured value of the biochemical marker of collagen type II resorption, Hom is the measured homogeneity, Vol is the measured cartilage volume, Rgh is the measured cartilage roughness, Ar is the measured cartilage area and Bone is a measured rate of bone resorption marker.

Suitably, t=from −0.6 to +0.3, u=from −0.25 to +0.9, v=from −0.8 to +0.4, x=from −0.05 to +1.7, y=−0.1 to 3.0, and z=from 0.3 to 2.0, the units of Bone, Ar, Rhg, Deg, Hom and Vol being scaled so that each has a standard deviation of 1. Preferably, t=from −0.5 to +0.2, u=from −0.1 to +0.7, v=from −0.7 to 0, x=from 0.1 to 1.0, y=0 to 1.5, and z=from 0.4 to 1.5, the units of Bone, Ar, Rhg, Deg, Hom and Vol being scaled so that each has a standard deviation of 1. Optimally, t=−0.19, u=0.17, v=−0.43, x=0.31, y=0.29 and z=0.76, each ±20%, more preferably ±10%, still more preferably ±5%.

Optionally, the method includes further calculating a numerical index indicative of the present degree of osteoarthritis in each patient.

The invention includes in a further aspect, a method of screening an individual or group of patients for the likelihood of having future progression of osteoarthritis comprising determination of an index as described above. Such a screening method may further comprise in vitro measurement of at least one biochemical biomarker which is a measure of a rate of breakdown of a component of a joint and inclusion of such a measurement in the index such that a value of the biochemical marker indicative of a higher rate of breakdown of said joint component affects the index to make it predictive of more disease progression.

In a further aspect, the invention includes a method of selecting patients for participation in a clinical trial of a therapeutic treatment for osteoarthritis comprising calculating by a method as described a said prognostic index for each of a panel of candidate patients who satisfy diagnostic criteria indicative of osteoarthritis, and selecting patients having a prognostic index indicating a likelihood above a predetermined threshold of progression of the severity of their osteoarthritis at or above a predetermined rate. Patients may be further selected for participation on the basis of having a diagnosis of osteoarthritis of a predetermined level of severity, preferably an early stage of osteoarthritis.

In a further aspect, the invention includes a computer programmed to accept as inputs measured values of biomarkers and to calculate an index as described, and includes also an instruction set for a computer to carry out said computation.

### BRIEF DESCRIPTION OF THE SEVERAL VIEWS OF THE DRAWINGS

The invention will be further described and illustrated with reference to the studies described below and the accompanying drawings, in which:

FIG. 1 shows a ROC diagram comparing the diagnostic capability of individual biomarkers and the aggregate index longevity_{diag} (see below);

FIG. 2 shows a comparison of the prognostic ability of individual biomarkers and the aggregate index longevity_{prog} (see below);

FIG. 3 shows the difference in articular cartilage volume measurements for patients categorised as ‘Non-progressors’ and as ‘Progressors’ in a study population; and

FIG. 4 shows the same as FIG. 3 but with the volume measurements corrected to allow for expected age related changes.

### DETAILED DESCRIPTION OF THE INVENTION

### STUDIES

To investigate how biomarker values can be combined to discriminate between patients with early stage osteoarthritis with a higher and lower probability of disease progression we carried out the following study. Biomarkers from radiographs, urine samples, and MRI for this study were acquired at baseline (BL), after 1 week for a subgroup, and then at follow-up after 21 months (FU). A subgroup had BL data re-acquired for precision evaluation.

The study included 159 randomly selected men and women such that the population had a normal group with a large age span as well as a large group with elevated risk of having knee OA. The risk group was selected based on age and known knee problems. The exclusion criteria ensured that none of the subjects had previous knee joint replacement, other joint diseases (e.g. rheumatoid arthritis, Paget's disease, joint fractures, hyperparathyroidism, hyper- and hypothyroidism), contraindications for performing MRI examination, or were receiving medication affecting bone and/or cartilage (e.g. bisphosphonates, vitamin D, hormones, SERMs, prednisolone, anabolic androgens, and PTH).

From this base collection of 318 left and right knees, 5 knees were excluded due to inferior imaging quality. Another 25 knees were used for training of the automatic MRI quantification methods and excluded from the evaluation set. Furthermore, a single subject was excluded since a urine sample was not acquired. Thereby a total of 287 knees were in the evaluation set at BL. A subgroup of 31 knees had imaging data acquired again a week after BL. At FU, 250 knees attended.

For each test subject age, sex, weight, and height were recorded at baseline and follow-up. At BL, 51% of the evaluation knees were healthy with a distribution of level of OA scored by Kellgren and Lawrence index (KL) of [145, 87, 30, 24, 1] (for KL 0, 1, 2, 3 and 4). For the rescan subgroup, 35% were healthy with KL [11, 13, 2, 5, 0]. At FU, 103 of the healthy had remained at KL 0 and 25 had progressed. Additionally, 10 of those with OA at BL had progressed.

Digital radiographs of the knees were acquired with the subject standing in a weight bearing position with the knees slightly flexed and the feet rotated externally. The SynaFlex (developed by Synarc) was used to ensure reproducibility of the foot orientation and knee flexing. Focus film distance was 1.0 m and tube angulation 10° (the MTP view modified for fixed angle. Radiographs were acquired in the posterior-anterior position, while the central beam was displayed directly to the mid point of the line through both popliteal regions. Radiographs of both knees were acquired simultaneously. For each x-ray, the medial tibio-femoral compartment was scored by inspection by a trained radiologist. KL was scored by qualitative evaluation of osteophytes, joint gap narrowing, and subchondral bone sclerosis for severe cases. JSW was measured by manually marking the narrowest gap between tibia and femur. In addition, the width of the tibial plateau was measured as a quantification of the knee size—covering both medial and lateral compartments but excluding possible osteophytes.

For all subjects, fasting morning urine sample were collected (second void). From these, urinary levels of collagen type II C-telopeptide fragments were measured by the CartiLaps ELISA assay (CTX-II). This assay uses a highly specific monoclonal antibody MAbF46 specific for a 6-amino acid epitope (EKGPDP) derived from the collagen type II C-telopeptide (3). CTX-II was corrected to urinary creatinine as assessed by a standard calorimetric method. To reduce the variability of the CTX-II measurements and to allow precision evaluation, baseline values were calculated as the mean of two separate determinations. For the statistical analysis done per knee, we used the simplifying assumption that each knee contributed equally to the CTX-II scores. Furthermore, for the statistical analysis, the CTX-II values were logarithmically transformed to obtain normality and symmetry of variance.

MRI scans were acquired from a low-field 0.18T Esaote C-span scanner dedicated to extremity imaging. A single knee coil was used. We used a sagittal Turbo 3D T1 sequence with near-isotropic voxels (40° flip angle, TR 50 ms, TE 16 ms, scan time approximately 10 minutes, resolution 0.7 mm×0.7 mm×0.8 mm). The scans had approximately 110 slices (depending on the knee size) and each slice 256×256 pixels. Near-isotropic voxels are suitable for 3D image analysis and shape modeling in general—and are also suitable for cartilage quantification (20). The subjects were scanned in supine position with no load-bearing during or prior to scanning—except for the short walk to the scanner.

The 25 scans in the training collection were segmented by slice-wise outlining of the medial tibial and femoral cartilage compartments by an expert radiologist. These segmentations were used to train a voxel classification scheme based on supervised learning in a kNN framework including multi-scale Gaussian derivative features (21). This voxel classification method provides automatic segmentation of the tibial and femoral cartilage compartments.

From the segmentations, volume and surface area were computed (MT.VC, MF.VC, MTF.VC, MT.AC, MF.AC, and MTF.AC using the nomenclature of (22)). Furthermore, the cartilage homogeneity was quantified as 1-entropy, with signal intensity entropy computed in the compartments (14) (MT.HomC, MF.HomC, MTF.HomC). Entropy quantifies the complexity of the intensity histogram, so cartilage with more uniform intensity has lower entropy (higher homogeneity). Since the scans are T1, this measure of homogeneity is related to water distribution and proteoglycan concentration. Also, clear definition of the internal cartilage layers will be imaged by separate intensities and contribute to higher entropy. Therefore, a loss of structural integrity may lead to lower entropy and higher cartilage homogeneity.

The surface roughness (inverse smoothness) was quantified for the tibial compartment by measuring the mean surface curvature over a region-of-interest (ROI) including the central load-bearing region and approximately half of the cartilage surface (MT.SmoClAB). The surface curvature was estimated using a surface evolution scheme driven by a partial differential equation at fine-scale resolution (8,26,23). Fibrillation and minor focal lesions lead to decreased smoothness.

For the remaining quantifications, a statistical cartilage sheet shape model was fitted to the segmented tibial cartilage sheets. By training the model on healthy knees, the resulting cartilage model covers the bone area that the a healthy cartilage sheet would cover (24). Thereby, the measured mean thickness was including denuded regions with zero thickness (MT.ThCtAB). Additionally, the thickness map 10% quantile was used as a measure targeting focal thinning related to local lesions (denoted MT.ThCQ). Finally, the mean surface curvature of the shape model was analyzed. Due to model regularization this coarse scale curvature relates to the overall bending of the sheet and is therefore indirectly related to the congruity of the joint. This simplified congruity measure (MT.ConClAB) was quantified as the mean inverse curvature across the ROI (FIG. 2D) also used for the roughness measure (27,8,26,23).

All steps performed on the MRI—including segmentation, shape model deformation and marker quantification—are done in a fully automated computer-based framework in 3D (rather than in each individual MRI slice).

We investigated the performance of combinations of the individual markers. Within the field of pattern recognition, various methods exist for combining markers in linear, non-linear or non-parametric fashion (such as quadratic discriminant analysis, support vector machines or kNN classifiers). We chose to limit ourselves to combinations defined by linear discriminant analysis (LDA) since it offers direct understanding of the aggregate biomarker as a simple weighted sum of the individual markers.

We investigated combinations of all the available markers. However, using only a subset of markers may in some cases provide better performance—both since some individual markers may not provide discrimination by themselves but also because of potential problems with overfitting and lack of generalization caused by the classical “high dimensionality, low sample size” problem.

We composed groups of markers defined by the marker modalities: demographic (D), biochemical (B), radiographic (X), and MRI (M). Accordingly, we denote an aggregate marker composed of biochemical, MRI, and radiographic markers by BMX. Furthermore, we investigated pseudo-optimal subsets of these groups (as explained below). The full group was denoted All BMX whereas the optimal subset was denoted Opti BMX.

Due to the combinatorial explosion it was in-feasible to evaluate all possible marker subsets (with 19 individual markers, there are 2¹⁹=524288 possible subsets). Therefore, we used a heuristic approach where we evaluated all subsets with up to three markers; and additionally by a “greedy forward selection” scheme where each subset was composed by first selecting the optimal individual marker, and by iteratively adding the single marker that provided the optimal combination with the already selected marker subset. This heuristic feature selection approach does not guarantee that the optimal subset is discovered—hence the term pseudo-optimal.

Finally, we evaluated combinations of biochemical and MRI-based markers for cartilage breakdown, quantity and quality. We denote a combination of CTX-II, volume, and homogeneity as an aggregate marker longevity_{basic}. A more comprehensive combination adding area (that combined with volume can provide an additional aspect of quality) and roughness (additional marker for quality), we denoted longevity_{prog}.

We evaluated the diagnostic and prognostic biomarker performance for individual and aggregate markers equivalently (individual markers are trivial aggregate markers consisting of a single marker).

When performing LDA using several biomarkers, the resulting combination is prone to overfitting/overtraining when the number of weighting parameters is high relative to the sample size, and the aggregate marker weights can be optimized to model arbitrary measurement variations that are not representative of the actual disease progression. Thereby, the apparent performance for the resulting aggregate marker will not generalize to other populations. Therefore, we performed an evaluation where the population was repeatedly split randomly into two sub-populations with approximately equal size and distribution of levels of OA. For each split, we optimized the weights for the aggregate biomarker on one training sub-population (using LDA) and evaluated the resulting aggregate marker on the other evaluation sub-population. The median performance on the evaluation sub-populations gives an estimate of the actual performance of the aggregate marker that will reveal lack of generalization. We used 500 repetitions.

The diagnostic performance was defined as the ability of the BL marker values to separate healthy or borderline cases (KL≦1) from OA knees (KL>1) and evaluated by p-value from MANOVA (p) (based on Hotelling's T² test, by corresponding required sample size from power analysis (n), and the area under the receiver-operator-characteristics curve (AUC).

The prognostic performance was defined as the ability of the BL values to separate healthy non-progressors (KL 0 at BL and FU) from early progressors (KL 0 at BL and KL>0 at FU) and evaluated by p, n, and the odd's ratio (OR). Due to the number of evaluated biomarkers, Bonferroni correction suggests that a significance level of around p=0.005 is appropriate.

The diagnostic and prognostic abilities of each individual and the aggregate markers are shown in Table 1.

TABLE 1
Performance results for the individual and aggregate biomarkers for
use as diagnostic (KL ≦ 1 vs KL > 1), prognostic (early progressors
vs non-progressors), and efficacy markers evaluated on the 21-months
longitudinal study with 287 knees at BL and 250 knees at FU. Sample
size scores are excluded for non-significant markers (p > 0.01).

| | Diagnostic | | | Prognostic | | |
|---|---|---|---|---|---|---|
| Biomarker | p | n | AUC | P | n | OR |
| Gender | 0.67 | — | 0.52 | 0.14 | — | 1.9 |
| BMI | 0.0000 | 38 | 0.75 | 0.0032 | 81 | 5.4 |
| JSW | 0.0000 | 37 | 0.73 | 0.27 | — | 1.8 |
| Width: MLT.Wi | 0.049 | — | 0.59 | 0.0065 | 86 | 3.5 |
| CTX-II | 0.0000 | 54 | 0.71 | 0.02 | 130 | 5.9 |
| Volume: MT.VC | 0.32 | — | 0.53 | 0.01 | 90 | 4.7 |
| Volume: MF.VC | 0.46 | — | 0.51 | 0.0035 | 72 | 5.2 |
| Volume: MTF.VC | 0.40 | — | 0.52 | 0.0039 | 73 | 5.2 |
| Area: MT.AC | 0.23 | — | 0.54 | 0.0061 | 78 | 4.4 |
| Area: MF.AC | 0.82 | — | 0.53 | 0.0048 | 79 | 5.6 |
| Area: MTF.AC | 0.59 | — | 0.50 | 0.0042 | 75 | 5.6 |
| Thickness: MT.ThCtAB | 0.092 | — | 0.56 | 0.023 | — | 3.8 |
| Thickness: MT.ThCtQ | 0.0000 | 54 | 0.71 | 0.12 | — | 2.6 |
| Congruity: | 0.0000 | 46 | 0.71 | 0.89 | — | 1.6 |
| MT.CongClAB | | | | | | |
| Roughness: | 0.0000 | 29 | 0.78 | 0.11 | — | 2.2 |
| MT.RouClAB | | | | | | |
| Homogeneity: | 0.0003 | 114 | 0.66 | 0.0023 | 69 | 5.1 |
| MT.HomC | | | | | | |
| Homogeneity: MF.HomC | 0.0003 | 128 | 0.62 | 0.87 | — | 1.6 |
| Homogeneity: | 0.0001 | 108 | 0.64 | 0.92 | — | 1.6 |
| MTF.HomC | | | | | | |
| All BMXD | 1 | 15 | 0.86 | 1 | 108 | 4.3 |
| All BMX | 1 | 16 | 0.84 | 1 | 209 | 2.8 |
| All MRI | 1 | 20 | 0.81 | 1 | 98 | 4.0 |
| Opti BMXD | 0.0000 | 17 | 0.83 | 0.0001 | 36 | 13.2 |
| Opti BMX | 0.0000 | 22 | 0.80 | 0.0001 | 35 | 12.4 |
| Opti MRI | 0.0000 | 22 | 0.80 | 0.001 | 47 | 10.9 |
| Longevity_{basic} | 0.0000 | 53 | 0.71 | 0.0024 | 65 | 6.0 |
| Longevity_{prog} | 0.0000 | 22 | 0.81 | 0.0001 | 35 | 12.4 |

JSW performed well as diagnostic marker (AUC 0.73). Since it is contained in the definition of KL, this was expected. The best individual diagnostic marker was cartilage roughness (AUC 0.78, n 29). The best aggregate diagnostic marker was the one combining all available individual markers (AUC 0.86, n 15). However, many of the other aggregate markers also demonstrated good diagnostic performance, including those combining all MRI markers (AUC 0.82, n 20) and the cartilage Longevity marker (AUC 0.81, n 22).

Several individual markers demonstrated prognostic ability, among these CTX-II (OR 5.9), cartilage volume (OR 5.2), and cartilage homogeneity (OR 5.1). JSW seemed inappropriate as a prognostic marker (p=0.27). Again, several of the aggregate markers demonstrated superior performance compared to the individual markers. The cartilage longevity_{prog} marker proved to be the optimal subset of all available individual biochemical, MRI, and radiograph markers (OR 12.4). This was composed of uCTX-II, homogeneity (MT.HomC), volume (MF.VC), smoothness (MT.SmoClAB), and area (MF.AC) and is designated longevity_{prog}.

When the individual biomarkers are expressed in the units in which they are measured, the weights for each biomarker assigned by LDA are unit dependent, e.g.

Longevity_{basic}=−0.018·uCTX-II−0.9998·MT.HomC−0.000009·MF.VC

When the individual markers are rescaled to have standard deviation one (denoted by underlining them below), the optimal weights used in the aggregate markers give an impression of the importance of each marker. As examples, the diagnostic and prognostic cartilage longevity markers were (Hom: MT.HomC, Rough: MT.RoughC, Vol: MF.VC, Area: MF.AC):

Longevity_{diag}=−0.45·CTX-II−0.26·Hom−0.84·Rough+0.07·Vol−0.14·Area

Longevity_{basic}=−0.44·CTX-II−0.65·Hom−0.63·Vol

Longevity_{prog}=−0.20·CTX-II−0.30·Hom−0.17·Rough−0.78·Vol+0.48·Area

The sign of the weights show whether increased values are prognostic of progression of OA. However, it is irrelevant whether the weights are expressed such that the index is positive or negative i.e. one can multiply all of the weights by −1, or indeed by any number. Elevated CTX-II reduces cartilage longevity (i.e. an increased risk of OA progression). Increased homogeneity and roughness reduce longevity. Increased volume and decreased area reduce longevity. That increased homogeneity is prognostic of OA progression is not surprising since increased homogeneity has also been shown to be related to the current degree of OA. However, it is surprising that increased volume implies an increased risk of OA progression.

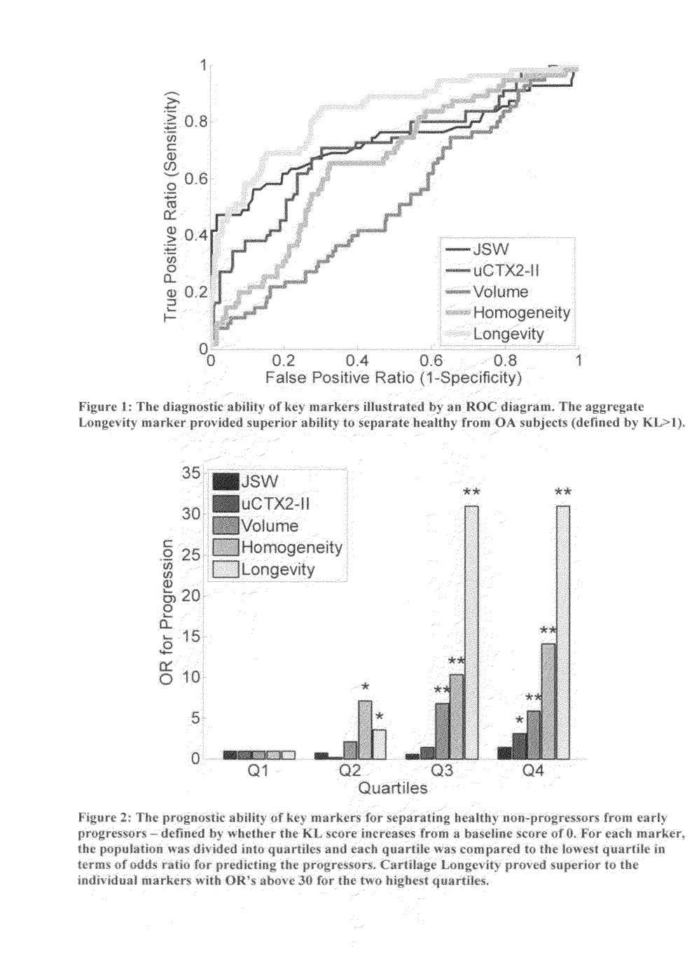

In the following, we show further results for these aggregate cartilage Longevity markers. These aggregate cartilage longevity markers are compared to the key individual markers (CTX-II, JSW, volume, and homogeneity) in FIGS. 1 and 2. The ROC curves in FIG. 1 show that both JSW and longevity_{diag} were able to diagnose 47% true positives with 4.7% false positives. From there, the longevity_{diag} marker proved better at diagnosing the more borderline cases.

FIG. 2 elaborates on the prognostic performance. For each marker the scores were split into quartiles and the predictive power of elevated scores were computed by comparison to the lowest quartile. Scores in the two upper quartiles of the longevity_{prog} cartilage marker provided superior predictive ability (OR>30).

When adjusting the longevity markers for gender, age and BMI, the diagnostic marker retained the performance of the unadjusted (AUC 0.80, n 22). Contrarily, the best unadjusted diagnostic marker combining all available individual markers had a drop in performance after adjustment (AUC 0.74, n 30).

The prognostic longevity_{prog} marker also retains equivalent performance (OR 12.0). For comparison, the aggregate marker combining the optimal subset of all markers goes to 4.7 after adjustment.

The results above were evaluated with analysis per knee. When the radiograph and MRI measurements for left and right knees are averaged, analysis per subject can be performed. This leaves the performance of both the diagnostic longevity_{diag} marker (AUC 0.82, n 18) and the prognostic longevity_{prog} marker (OR 22.0) similar or improved compared to the per-knee results.

The weights in the linear combinations allow specialization of the aggregate markers to other tasks. For instance, the diagnostic markers can be trained to diagnose very early OA (KL 0 from KL>0). For that task, the golden standard marker JSW performs somewhat worse (n 66, AUC 0.68 compared to n 37, AUC 0.73) whereas the best aggregate marker, Opti BMXD, remains similar (n 16, AUC 0.84 compared to n 17, AUC 0.83).

We have previously used MRI cartilage markers normalized by the width of the tibial plateau to adjust for joint size. This improved the diagnostic ability of the individual markers (27) and can also be used in the aggregate markers (28). Using MRI markers normalized by knee width (27), the performance of the prognostic longevity improved from OR 12.4 to 16.1.

The complexity of OA implies that biomarker development is challenging. There are many factors in the onset of OA including genetics, trauma, biomechanics, weight, and exercise. In addition, the different phases of OA may entail different driving pathological mechanisms—e.g. during very early OA, structural changes are observed that cause increased turnover of cartilage and bone. This may be followed by cartilage fibrillation, thickening of the subchondral bone, bone lesion edema, osteophytes, focal cartilage lesions, and during the later stages of OA cartilage loss leading to denudation may be observed (for models of these stages, see (29,30)).

The fact that aggregate markers were superior supports that markers from different modalities can complement each other. However, an aggregate index combining all possible markers which could be included is not optimal. This introduces a risk for severe performance overestimation due to too small population if the evaluation is carried out directly on the entire population. Instead, we use repeated random sampling of sub-populations. As an example of the need for such an evaluation strategy, a comparison of the median performance for the prognostic “All BMXD” aggregate marker in the training subsets (n 8, OR ∞) demonstrates severe overtraining compared to the performance in the evaluation subsets (n 108, OR 4.3). Therefore, a robust subset selection method like the one employed here is essential.

Even with very similar markers, superior performance of aggregate markers could be achieved through improved precision due to reducing measurement variation by repeated similar quantifications. However, for instance, for the cartilage longevity_{prog} marker the precision is 1.1% (CV on the scan-rescan pairs and the repeated CTX-II measurements). For comparison, cartilage homogeneity has 0.9%. Therefore, improved performance is rather due to the combination of the different aspects of cartilage quantity, quality, and breakdown measured from different modalities.

Currently, the accepted outcome measures in clinical studies of DMOADs are pain, function, and JSW. Both pain and function are complicated to measure in an objective way, and JSW is likely not a very sensitive marker for OA progression. Therefore, the most solid clinical end point, JRS, remains the most reliable outcome measure. Due to the slow progression of OA, an estimate of the time to JRS is a more appealing efficacy marker for a clinical study. However, a lack of an objective estimation makes this unfeasible at the moment. Therefore, JSW, pain, and function so far remain the most accepted clinical study outcome measures. Clinical studies do not rely on outcome measures alone. The ability to select a study population with a risk for disease progression is equally crucial.

The above results demonstrate that use of JSW in clinical studies may not be optimal. JSW was unsuitable as a prognostic marker and the performance as diagnostic marker was expected since JSW is an integral part of the KL score used to define the level of OA. Even with this inherent bias, JSW was outperformed by the individual roughness marker from MRI. Furthermore, when inspecting the ROC diagram in FIG. 1, it is apparent that JSW is particularly effective in diagnosing the “easy” subjects (left end of curves)—the ones with severe OA corresponding to very low JSW. However, for the earlier stages of OA, also homogeneity and in particular cartilage longevity outperforms JSW.

The aggregate biomarker framework is very general as exemplified by the alternative aggregate diagnostic Opti BMXD marker for very early OA. The generality allows inclusion of alternative cartilage markers, such as the markers normalized by knee size. These normalized markers are by themselves non-linear combinations of the included MRI markers and the Width marker.

A natural extension of the work described above is to include MRI markers targeting bone, meniscus, and other joint structures; and to include additional biochemical markers targeting bone turnover, cartilage formation, synovitis and other central processes. Thereby, the aggregate markers could become more similar to frameworks such as WORMS and the “Knee Osteoarthritis Scoring System”, KOSS (35). These scoring systems provide a semi-quantitative score based on inspection of MRI for the presence/severity of disease-related parameters such as cartilage lesions, bone marrow abnormalities, and meniscal abnormalities. However, in addition to the computational methodology that allow specialization to different biomarker tasks, a major difference between WORMS/KOSS and the above described framework is the use of continuous markers, rather than categorical. Continuous markers are likely to provide higher sensitivity.

The combination of cartilage quantity, quality, and breakdown may also be used to provide an estimate of the remaining cartilage life-span which could be a central factor in an objective estimate for a time-to-JRS marker.

The use of aggregate markers implies quantification of several individual markers, introducing a potential measurement bottle-neck. Even for volumetric MRI markers, manual or semi-automatic annotation is quite time-consuming. For advanced 3D shape-related markers (such as the congruity or roughness markers) manual annotation is not feasible. The present study relied on fully automated computer-based low-field MRI methods for cartilage status assessment and a standardized biochemical marker that is measured through simple standard ELISA techniques. Thereby, the presented aggregate markers can be readily applied in large, multi-center studies without the introduction of a reader bottle-neck. In particular, the prognostic cartilage longevity_{prog} marker could by itself ensure the selection of a suitable high-risk study population and thereby facilitate a positive clinical study outcome for a DMOAD.

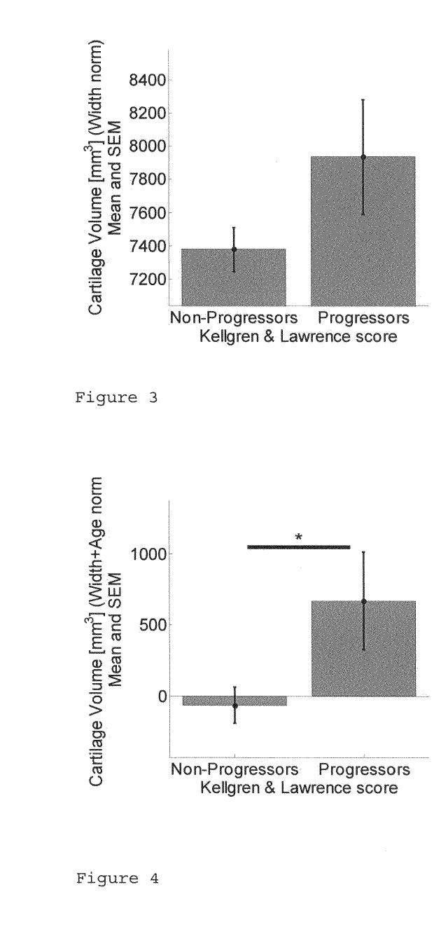

We here demonstrate that combinations of biochemical and MRI-based biomarkers can provide a superior prognostic OA marker or index. It is particularly surprising that a relatively large cartilage volume should predispose to a higher rate of OA progression in the measured joint. Indeed, we do not currently have a fully convincing explanation for this phenomenon. It is not for instance the result of a correlation between the age of the patient and the volume of cartilage, with younger patients having a higher volume and a predisposition to more active disease. Whilst we find that disease free women do indeed seem to lose some cartilage volume with age, we do not find this in men. FIG. 3 shows the difference in volume measurements for patients categorised as ‘Non-progressors’ and as ‘Progressors’ in our study population. FIG. 4 shows the same but with the volume measurements corrected to allow for expected age related changes. As shown in FIGS. 3 and 4 if the age related changes in cartilage volume in our study group of patients are taken into account, the age corrected volumes are more rather than less predictive of OA progression.

Looking further at optimised aggregate prognostic markers, in the following, we investigate the sensitivity of the prognostic longevity markers with respect to the weights in the optimal linear combinations. This is done for the basic longevity marker (composed of CTX-II, homogeneity MT.HomC, and volume MF.VC) and the longevity_{prog} marker (composed of CTX-II, homogeneity MT.HomC, roughness MT.RoughC, volume MF.VC, and area MF.AC).

As stated above, the prognostic longevity marker is:

Longevity_{prog}=−0.20·CTX-II−0.30·Hom−0.17·Rough−0.78·Vol+0.48·Area

The prognostic basic longevity marker is:

Longevity_{basic}=−0.44·CTX-II−0.65·Hom−0.63·Vol

For comparison, a marker using only the quantitative volume and area markers would be:

Quantity_{prog}=−1.00·Vol−0.03·Area

The effect of variations in these markers has been explored as follows.

The performances, as odds ratios, for each of these aggregate markers are as follows:

| Longevity_{prog} | Longevity_{basic} | Quantity_{prog} |
|---|---|---|
| 24.1 | 16.3 | 5.2 |

The performance of the specific Longevity_{prog} marker is evaluated to OR 24.1. Note that this is higher than the 12.4 given as the result above. This over-estimation of the OR is due to the choice of a specific set of weights determined from the entire population. The evaluation is performed by repeated generation of training and test sub-populations. When the weights are set to specific values, they are not chosen during training, and therefore there will be no possibility for poor generalization to the test set. And the performance will be better because the general weights were determined on the entire population—and thereby partly on the test populations. Therefore, the results reported below on the test sets will be over-estimating the performance compared to the previous (more correct) results. The purpose of the investigation here is rather to see how sensitive the aggregate markers are to changes in the weights rather than to see the actual performance.

The results above demonstrate how cartilage markers from MRI and systemic samples can be combined into a cartilage longevity marker.

For a more comprehensive marker of “Joint Longevity” it could be relevant to add markers for other joint processes. These could be markers for presence of osteophytes, changes in the trabecular bone structure, or meniscal lesions—such as suggested by the aggregate WORMS score (based on semi-quantitative manual MRI observations of different tissues). Here, we demonstrate this by adding the serum-based CTX-I marker that quantifies breakdown of collagen type I in bone. We denote the combination of CTX-I and the cartilage longevity marker as “Joint Longevity”.

The optimised prognostic joint longevity marker is:

Joint Longevity_{prog}=−0.31·CTX-II+0.19·CTX-I−0.29·Hom−0.17·Rough−0.76·Vol+0.43·Area

The joint longevity marker is in fact superior to the cartilage longevity marker (OR 27.6 versus 24.1).

In the following, we investigate how sensitive these aggregate markers are to changes in the weightings/parameters. This is done by evaluating the result of replacing each weight with double the value, half the value, and zero. The results are given in the table below. Each column treats an aggregate marker. The first row gives the OR for predicting early progression for the specific markers given above. For each individual marker are then given three numbers: the OR when the weight is doubled, halved, and set to zero.

| | | | Joint | |
|---|---|---|---|---|
| | Longevity_{prog} | Longevity_{basic} | Longevity_{prog} | Quantity_{prog} |
| | 24.1 | 16.3 | 27.6 | 5.2 |
| CTX-II | 20.5/19.5/15.0 | 16.1/16.3/15.7 | 22.2/18.9/12.4 | |
| CTX-I | | | 20.2/24.5/22.0 | |
| Hom | 18.9/18.5/12.0 | 16.1/15.0/6.6 | 20.5/20.2/15.0 | |
| Rough | 20.2/23.8/20.2 | | 29.1/22.5/20.2 | |
| Vol | 10.0/6.1/1.4 | 14.5/14.5/7.5 | 13.2/12.4/1.8 | 5.2/5.2/5.6 |
| Area | 5.6/22.0/14.5 | | 11.4/22.0/18.5 | 5.2/5.2/5.2 |

The ORs in the table reveal that in particular quantity and quality, represented here by homogeneity and volume, are essential for the aggregate markers. However, while volume is essential as an ingredient, it is not very effective on its own (OR 5.2); neither is the aggregate marker focusing on cartilage quantity combining volume and area. The roughness marker seems to be least essential, and fairly large changes of the weight are possible with relatively small performance drop.

These results support that the presence of measures of quantity and quality are essential, although all aspects (quantity, quality, and breakdown) are important.

In order to establish appropriate ranges for each weight in each aggregate marker, we defined less and more preferred fiducial performance thresholds of (1) one half of the performance of Longevity_{prog} (so OR 12), and (2) two-thirds the performance of Longevity_{prog} (so OR 16) and determined the limits for each weight where the performance drops below each of these thresholds. This results in the weight intervals given in the table below. The weights are those corresponding to the individual biomarkers rescaled to unit standard deviation. For each weight is given the optimal value and then the interval. MRI-VAprog is an aggregate marker based on volume and area of cartilage determined by MRI and MRI-HVprog is an index based on a combination of MRI determined homogeneity and volume.

| | Longevity_{prog} | LongBasic_{prog} | JointLongevity_{prog} | MRI-VA_{prog} | MRI-HV_{prog} |
|---|---|---|---|---|---|
| CTX-II | −0.20 | −0.44 | −0.31 | | |
| (Deg) | [−0.8; −0.05] | [−1.3; 0.0] | [−1.0; −0.1] | | |
| | [−1.3; 0.05] | [−1.7; 0.1] | [−1.7; 0.05] | | |
| CTX-I | | | 0.19 | | |
| (Bone) | | | [0.5; −0.2] | | |
| | | | [0.6; −0.3] | | |
| Hom | −0.30 | −0.65 | −0.29 | | −0.72 |
| | [−1.2; −0.05] | [−1.9; −0.3] | [−1.5; 0.0] | | None |
| | [−2.5; 0.0] | [−3.2; −0.1] | [−3.0; 0.1] | | [−4.3; −0.4] |
| Rgh | −0.17 | | −0.17 | | |
| | [−0.6; 0.05] | | [−0.7; 0.1] | | |
| | [−0.7; 0.15] | | [−0.9; 0.25] | | |
| Vol | −0.78 | −0.63 | −0.76 | −1.00 | −0.69 |
| | [−1.2; −0.5] | [−1.2; −0.3] | [−1.5; −0.4] | None | None |
| | [−1.5; −0.4] | [−2.5; −0.1] | [−2.0; −0.3] | None | [−1.2; −0.1] |
| Ar | 0.48 | | 0.43 | −0.03 | |
| | [0.6; 0.1] | | [0.7; 0] | None | |
| | [0.7; −0.2] | | [0.8; −0.4] | None | |

The term “None” means that the aggregate marker using only cartilage quantity (volume) and area performs below the threshold for any weights and that the aggregate marker based just on volume and homogeneity performs below the higher threshold of OR=16). Notably, ‘area’ can substitute for homogeneity as a quality biomarker in the more sophisticated indices, for instance an odds ratio of 16 can be achieved using the LongBasic_{prog} index with the coefficient for Hom set at zero.

It should be noted that the performance of each aggregate marker is invariant to overall scaling of the weights—i.e. if all weights are doubled simultaneously or reversed in sign, the performance is not affected. Therefore, we consider any two combinations of weights to be equivalent if the inter-weight ratios are identical.

Also, the performance of the aggregate markers is invariant to the choice of units—but this affects the specific weights. If, for instance, the volume is measured in litres instead of mm³, the weight will simply be rescaled by the appropriate number of order of magnitudes. Therefore, we consider differences in weights due to differences in units to be irrelevant—and to result in equivalent aggregate markers. When the individual markers are rescaled to standard deviation one, the invariance to choice of units is automatically obtained.

In this specification, unless expressly otherwise indicated, the word ‘or’ is used in the sense of an operator that returns a true value when either or both of the stated conditions is met, as opposed to the operator ‘exclusive or’ which requires that only one of the conditions is met. The word ‘comprising’ is used in the sense of ‘including’ rather than in to mean ‘consisting of’. All prior teachings acknowledged above are hereby incorporated by reference in their entirety. Acknowledgement of prior art in this specification is not an admission or representation that such prior art forms part of the common general knowledge in Australia or elsewhere.

### REFERENCES

1. Bauer D C, Hunter D J, Abramson S B, Attur M, Corr M, Felson D et al (2006) Classification of osteoarthritis biomarkers: a proposed approach. Osteoarthritis Cartilage 14 (8): 723-727.
2. Rousseau J C and Delmas P D (2007) Biological markers in osteoarthritis. Nat Clin Pract. Rheumatol 3 (6): 346-356.
3. Christgau S, Garnero P, Fledelius C, Moniz C, Ensig M, Gineyts E et al (2001) Collagen type II C-telopeptide fragments as an index of cartilage degradation. Bone 29 (3): 209-215.
4. Sumer E U, Sondergaard B C, Rousseau J C, Delmas P D, Fosang A J, Karsdal M A et al (2007) MMP and non-MMP-mediated release of aggrecan and its fragments from articular cartilage: a comparative study of three different aggrecan and glycosaminoglycan assays. Osteoarthritis Cartilage 15 (2): 212-221.
5. Schaller S, Henriksen K, Hoegh-Andersen P, Sondergaard B C, Sumer E U, Tanko L B et al (2005) In vitro, ex vivo, and in vivo methodological approaches for studying therapeutic targets of osteoporosis and degenerative joint diseases: how biomarkers can assist? Assay. Drug Dev. Technol. 3 (5): 553-580.
6. Stammberger T, Eckstein F, Michaelis M, Englmeier K H, and Reiser M (1999) Interobserver Reproducibility of Quantitative Cartilage Measurements: Comparison of B-Spline Snakes and Manual Segmentation. Magnetic Resonance Imaging 17 (7): 1033-1042.
7. Tamez-Pena J G, Barbu-McInnis M, and Totterman S (2004) Knee cartilage extraction and bone-cartilage interface analysis from 3D MRI data sets. Proceedings SPIE(5370):1774-1784.
8. Folkesson J, Dam E B, Olsen O F, Pettersen P C, and Christiansen C (2007) Accuracy Evaluation of Automatic Quantification of the Articular Cartilage Surface Curvature from MRI. Academic Radiology 14 (10): 1221-1228.
9. Williams A, Sharma L, McKenzie C A, Prasad P V, and Burstein D (2005) Delayed gadolinium-enhanced magnetic resonance imaging of cartilage in knee osteoarthritis: findings at different radiographic stages of disease and relationship to malalignment. Arthritis Rheum 52 (11): 3528-3535.
10. Li X, Benjamin M C, Link T M, Castillo D D, Blumenkrantz G, Lozano J et al (2007) In vivoT(1rho) and T(2) mapping of articular cartilage in osteoarthritis of the knee using 3T MRI. Osteoarthritis Cartilage 15 (7): 789-797.
11. Qazi A A, Folkesson J, Pettersen P C, Karsdal M A, Christiansen C, and Dam E B (2007) Separation of healthy and early osteoarthritis by automatic quantification of cartilage homogeneity. Osteoarthritis and Cartilage Available online ahead of print.
12. Eckstein F, Cicuttini F, Raynauld J P, Waterton J C, and Peterfy C (2006) Magnetic resonance imaging (MRI) of articular cartilage in knee osteoarthritis (OA): morphological assessment. Osteoarthritis and Cartilage 14 (Supplement 1): 46-75.
13. Qi et al: Knee Surg Sports Traumatol Arthrosc 2007, July; 15(7): 869-78
14. Qazi A A, Dam E B, Nielsen M, Karsdal M A, Pettersen P C, Christiansen C. Acad Radiol. 2007 October; 14(10):1209-20 ‘Osteoarthritic cartilage is more homogeneous than healthy cartilage: identification of a superior region of interest colocalized with a major risk factor for osteoarthritis.
15. Bruyere et al: Ann Rheum Dis, 2006; 65: 1050-1054
16. Mazieres et al: Ann Rheum Dis, 2006; 65:354-359
17. Garnero et al: Arthritis Rheum, 2002, October; 46(10): 2649-52
18. Hunter et al: Arthritis Res Ther. 2007, Oct. 24; 9(5): R108
19. Roux-Lombard et al: Rheumatology 2001; 40: 544-551
20. Xia Y (2003) The total volume and the complete thickness of articular cartilage determined by MRI. Osteoarthritis and Cartilage 11 (7): 473-474.
21. Folkesson J, Dam E B, Olsen O F, Pettersen P C, and Christiansen C (2007) Segmenting Articular Cartilage Automatically Using a Voxel Classification Approach. IEEE Trans. on Medical Imaging 26 (1): 106-115.
22. Eckstein F, Ateshian G, Burgkart R, Burstein D, Cicuttini F, Dardzinski B et al (2006) Proposal for a Nomenclature for MRI based measures of articular cartilage in OA. Osteoarthritis and Cartilage 14 (10).
23. Folkesson J, Dam E B, Olsen O F, Pettersen P C, and Christiansen C (2006) Automatic Curvature Analysis of the Articular Cartilage Surface. MICCAI Joint Disease Workshop (http://www.diku.dk/˜erikdam/joint):17-24.
24. Dam E B, Folkesson J, Pettersen P C, and Christiansen C (2006) Automatic Cartilage Thickness Quantification using a Statistical Shape Model. MICCAI Joint Disease Workshop (http://www.diku.dk/˜erikdam/joint):42-49.
25. —left blank—
26. Folkesson J, Dam E B, Olsen O F, Karsdal M A, Pettersen P, and Christiansen C (2008) Automatic Quantication of Local and Global Articular Cartilage Surface Curvature: Biomarkers for Osteoarthritis Magnetic Resonance in Medicine In Print.
27. Dam E B, Folkesson J, Pettersen P C, and Christiansen C (2007) Automatic morphometric cartilage quantification in the medial tibial plateau from MRI for osteoarthritis grading. Osteoarthritis and Cartilage 15 (7): 808-818.
28. Dam, E. B., Loog, M., Christiansen, C., and Karsdal, M. A. Cartilage Longevity: A Prognostic OA Biomarker Combining Biochemical and MRI-Based Cartilage Markers. Osteoarthritis and Cartilage 15(Supplement C), C48. 2007. Ref Type: Abstract
29. Dam E B, Christiansen C, and Karsdal M A (2008) An osteoarthritis pathogenesis model for clinical studies with implications for intervention strategies, study population selection, and biomarker design. Arthritis Research and Therapy Submitted.
30. Altman R D and Gold G E (2007) Atlas of individual radiographic features in osteoarthritis, revised. Osteoarthritis Cartilage 15 Suppl A: A1-56.
31. Filidoro L, Dietrich O, Weber J, Rauch E, Oerther T, Wick M, Reiser M F, Glaser C. High-resolution diffusion tensor imaging of human patellar cartilage: feasibility and preliminary findings. Magn Reson Med. 2005 May; 53(5):993-8.
32. Tiderius C J, Svensson J, Leander P, Ola T, Dahlberg L. dGEMRIC (delayed gadolinium-enhanced MRI of cartilage) indicates adaptive capacity of human knee cartilage. Magn Reson Med. 2004 February; 51(2):286-90.

1. A computer based method for the calculation of a prognostic index in respect of osteoarthritis based on biochemical and imaging based biomarkers comprising inputting to or computing in a computational apparatus values of at least two biomarkers and calculating a said index in said computational apparatus by a mathematical combination of said values, wherein at least one said biomarker is a first imaging based biomarker which is a measure of the quantity of a cartilage in a joint compartment, and at least one said biomarker is a second imaging based biomarker relating to the quality of said cartilage in said joint compartment, and wherein a value of said first biomarker indicative of a larger quantity of cartilage affects the index to make it predictive of more disease progression, and a value of said second biochemical marker indicative of a greater departure from the quality of disease free cartilage affects the index to make it predictive of more risk of disease progression.

2. A method as claimed in claim 1, wherein more than 5 biomarkers are combined but such that no more than 5 of the combined biomarkers provide at least 70% of the information content of said index.

3. A method as claimed in claim 1, wherein no more than 6 biomarkers are combined to form said index.

4. A method as claimed in claim 1, wherein at least 3 biomarkers are combined to form said index.

5. A method as claimed in claim 1, wherein the said first imaging based biomarker relating to the quantity of cartilage is selected from the group consisting of cartilage thickness at a location, cartilage mean thickness,and cartilage volume, or cartilage thickness or volume measured in a anatomical compartment, a compartment sub-region, or in a region-of-interest, as measured from a digital image of the cartilage.

6. A method as claimed in claim 1, wherein said second imaging based biomarker relating to the quality of said cartilage is selected from the group consisting of congruity, surface curvature, surface smoothness, cartilage composition, cartilage fibre alignment and homogeneity, each as measured from a digital image of the cartilage.

7. A method as claimed in claim 1, wherein said first and second imaging based biomarkers are (1) cartilage volume and (2) cartilage homogeneity, and wherein greater homogeneity affects the index to make it predictive of more disease progression.

8. A method as claimed in claim 1, wherein said first imaging based biomarker relates to the joint compartment of a knee.

9. A method as claimed in claim 8, wherein said first imaging based biomarker is indicative of volume of at least one articular cartilage in said knee.

10. A method as claimed in claim 1, wherein at least three biomarkers are combined to form said index, and at least one said biomarker is a biochemical biomarker which is a measure of a rate of breakdown of a component of said joint, and a value of the biochemical marker indicative of a higher rate of breakdown of said joint component affects the index to make it predictive of more risk of disease progression.

11. A method as claimed in claim 10, wherein the said biochemical marker is a concentration measured in a body fluid sample of a cartilage degradation product.

12. A method as claimed in claim 11, wherein said cartilage degradation product is a peptide or group of related peptides produced by breakdown of a cartilage protein.

13. A method as claimed in claim 12, wherein the cartilage protein is collagen type II, aggrecan, or COMP.

14. A method as claimed in claim 13, wherein at least 3 biomarkers are combined to form said index which are (1) cartilage volume, (2) cartilage homogeneity, and (3) a biochemical marker of cartilage type II resorption.

15. A method as claimed in claim 13, wherein at least 5 biomarkers are combined to form said index which are (1) cartilage volume, (2) cartilage homogeneity, (3) a biochemical marker of collagen type II resorption, (4) cartilage roughness, and (5) cartilage area.

16. A method as claimed in claim 1, wherein at least one additional biomarker is included in said index which is indicative of the state of a structural component of the joint other than articular cartilage.

17. A method as claimed in claim 16, wherein a said at least one additional biomarker relates to bone formation or resorption, or changes in bone shape, or changes in meniscal cartilage.

18. A method as claimed in claim 1, wherein the index is calculated according to a linear weighted sum of the measured biomarkers.

19. A method as claimed in claim 1, wherein said index is calculated to provide the information content of I such that:
$$I = yHom + zVol + {\sum }_{n = 1}^{N} {a}_{n} {Other}_{n}$$
where y and z are numerical coefficients, Hom is the measured homogeneity, Vol is the measured cartilage volume, and where Otherₙ represents N further biomarkers each having a respective numerical coefficient aₙ, N being zero or an integer.

20. A method as claimed in claim 19, wherein said index is calculated to provide the information content of I such that:
$$I = xDeg + yHom + zVol + {\sum }_{n = 1}^{N} {a}_{n} {Other}_{n}$$
where x, y, and z are numerical coefficients and Deg is the measured value of the biochemical marker of collagen type II degradation, Hom is the measured homogeneity, and Vol is the measured cartilage volume, and where Otherₙ represents N further biomarkers each having a respective numerical coefficient aₙ, N being zero or an integer.

21. A method as claimed in claim 19, wherein said index is calculated to provide the information content of I such that:
$$I = xDeg + yHom + zVol + wRough + vArea + {\sum }_{n = 1}^{N} {a}_{n} {Other}_{n}$$
where v, w, x, y, and z are numerical coefficients and Deg is the measured value of the biochemical marker of collagen type II resorption, Hom is the measured homogeneity, Vol is the measured cartilage volume, Rough is the measured cartilage roughness and Area is a measured cartilage area, and where Otherₙ represents N further biomarkers each having a respective numerical coefficient aₙ, N being zero or an integer.

22. A method as claimed in claim 19, wherein said index is calculated to provide the information content of I such that:
I=yHom+zVol
where y and z are numerical coefficients, Hom is the measured homogeneity, Vol is the measured cartilage volume, and wherein y=from 0.4 to 4.3, and z=from 0.1 to 1.2, when the units of Hom and Vol are scaled so that each has a standard deviation of 1.

23. A method as claimed in claim 22, wherein y=0.72 and z=0.69, each ±20%.

24. A method as claimed in claim 19, wherein said index is calculated to provide the information content of I such that:
I=xDeg+yHom+zVol
where x, y, and z are numerical coefficients and Deg is the measured value of the biochemical marker of collagen type II resorption, Hom is the measured homogeneity, and Vol is the measured cartilage volume.

25. A method as claimed in claim 7, wherein x=from −0.1 to +1.7, y=from 0.1 to 3.2, and z=from 0.1 to 2.5, the units of Deg, Hom and Vol being scaled so that each has a standard deviation of 1.

26. A method as claimed in claim 24, wherein x=from 0.01 to 1.3, y=from 0.3 to 1.9, and z=from 0.3 to 1.2, the units of Deg, Hom and Vol being scaled so that each has a standard deviation of 1.

27. A method as claimed in claim 24, wherein x=0.44, y=0.65 and z=0.63, all ±20%.

28. A method as claimed in claim 19, wherein said index is calculated to provide the information content of I such that:
I=xDeg+yHom+zVol+uRgh+vAr
where u, v, x, y, and z are numerical coefficients and Deg is the measured value of the biochemical marker of collagen type II resorption, Hom is the measured homogeneity, Vol is the measured cartilage volume, Rgh is the measured cartilage roughness and Ar is the measured cartilage area.

29. A method as claimed in claim 19, wherein u=from −0.15 to +0.7, v=from −0.7 to +0.2, x=from −0.05 to +1.3, y=0 to 2.5, and z=from 0.4 to 1.5, the units of Vol, Rhg, Deg, Hom and Vol being scaled so that each has a standard deviation of 1.

30. A method as claimed in claim 28, wherein u=from −0.05 to +0.6, v=from −0.6 to −0.1, x=from 0.05 to 0.8, y=0.05 to 1.2, and z=from 0.5 to 1.2, the units of Deg, Hom and Vol being scaled so that each has a standard deviation of 1.

31. A method as claimed in claim 27, wherein u=0.17, v=−0.48, x=0.2, y=0.3 and z=0.78, all ±20%.

32. A method as claimed in claim 19, wherein said index is calculated to provide the information content of I such that:
I=xDeg+yHom+zVol+uRgh+vAr+tBone
where t, u, v, x, y, and z are numerical coefficients and Deg is the measured value of the biochemical marker of collagen type II resorption, Hom is the measured homogeneity, Vol is the measured cartilage volume, Rgh is the measured cartilage roughness, Ar is the measured cartilage area and Bone is a measured rate of bone resorption marker.

33. A method as claimed in claim 32, wherein t=from −0.6 to +0.3, u=from −0.25 to +0.9, v=from −0.8 to +0.4, x=from −0.05 to +1.7, y=−0.1 to 3.0, and z=from 0.3 to 2.0, the units of Bone, Ar, Rhg, Deg, Hom and Vol being scaled so that each has a standard deviation of 1.

34. A method as claimed in claim 33, wherein t=from −0.5 to +0.2, u=from −0.1 to +0.7, v=from −0.7 to 0, x=from 0.1 to 1.0, y=0 to 1.5, and z=from 0.4 to 1.5, the units of Bone, Ar, Rhg, Deg, Hom and Vol being scaled so that each has a standard deviation of 1.

35. A method as claimed in claim 34, wherein t=−0.19, u=0.17, v=−0.43, x=0.31, y=0.29 and z=0.76, all ±20%.

36. A method as claimed in claim 1, further comprising the calculation of a numerical index indicative of the present degree of osteoarthritis in each patient.

37. A method of screening an individual or group of patients for the likelihood of having future progression of osteoarthritis comprising determination from an image of a joint of a first imaging based biomarker which is a measure relating to the quantity of cartilage in a joint compartment and a second imaging based biomarker relating to the quality of said cartilage in said joint compartment, and combining said biomarker measurements into a quantitative index such that a value of said first imaging based biomarker indicative of a larger quantity of cartilage affects the index to make it predictive of more disease progression, a value of said second imaging based biochemical marker indicative of a greater departure from the quality of disease free cartilage affects the index to make it predictive of more disease progression.

38. A method of screening as claimed in claim 37, further comprising in vitro measurement of at least one biochemical biomarker which is a measure of a rate of breakdown of a component of a joint and, and a value of the biochemical marker indicative of a higher rate of breakdown of said joint component affects the index to make it predictive of more disease progression.

39. A method of selecting patients for participation in a clinical trial of a therapeutic treatment for osteoarthritis comprising calculating by a method as claimed in claim 1, a said prognostic index for each of a panel of candidate patients who satisfy diagnostic criteria indicative of osteoarthritis, and selecting patients having a prognostic index indicating a likelihood above a predetermined threshold of progression of the severity of their osteoarthritis at or above a predetermined rate.

40. A method as claimed in claim 39, wherein patients are further selected for participation on the basis of having a diagnosis of osteoarthritis of a predetermined level of severity.
